(19) United States
(12) Patent Application Publication
(10) Pub. No.: US 2001/0022823 A1
(43) Pub. Date: Sep. 20, 2001

(54) Method and system for multi-protocol clock recovery and generation

(76) Inventor: Pierre Renaud, Garineau (CA)

Correspondence Address: BORDEN LADNER GERVAIS, LLP, 1000 - 60 QUEEN STREET, OTTAWA, ON, K1P 5Y7, CA

(21) Appl. No.: 09/811,528

(22) Filed: Mar. 20, 2001

(30) Foreign Application Priority Data
Mar. 20, 2000 (CA) 2,301,436

(51) Int. Cl. H04L 7/02; H04L 7/00

(52) U.S. Cl. 375/359; 375/354

(57) ABSTRACT

A method and system for synchronizing a receiver's clock to the clock of a transmitter is disclosed herein. The disclosed system employs a digital clock synthesizer that uses patterns superimposed upon a receiver oscillator to synthesize a clock rate that approximates the clock rate of the transmitter. The pattern superimposed upon the receiver oscillator can be varied to allow for tracking of the variation in the transmitter clock.

### FIELD OF THE INVENTION

The present invention generally relates to a method and system for clock recovery and generation in a multi-protocol telecommunications environment. More particularly, the present invention relates to a method and system for clock recovery and generation in a multi-protocol broadband wireless digital modem architecture.

### BACKGROUND OF THE INVENTION

In the art of telecommunications it is often essential to synchronize the clocks of transmitting and receiving stations. Synchronization is essential when a hub or basestation is in bi-directional communication with multiple terminals that are each assigned a timeslot, or a frame, in which to transmit. A lack of proper synchronization between the terminals and the base station clock may result in the inability of a terminal to transmit without causing a collision with another terminal's data. Though in certain terrestrial systems collisions are acceptable, in heavy use systems, or systems with high latency times, collisions greatly degrade the quality of the communications link.

Additionally with real time data flows it is often essential to provide the data at a fixed rate from the terminal to another point. Lack of synchronization with the basestation clock may cause decoding problems for real time data.

Numerous solutions to synchronize the receiver clock to the transmitter clock have been developed. It is common practice for the transmitter to embed a timestamp in certain data units to facilitate the synchronization. The receiver typically employs a phase locked loop (PLL), using the difference between the receiver clock and the timestamp as a governing factor. Changing the voltage applied to a voltage-controlled oscillator (VCO) minimizes the difference between the timestamp and the receiver clock. As the difference between the timestamp and the receiver clock varies, so to does the voltage supplied to the VCO, allowing the receiver to synchronize to the transmitted timestamps.

This technique requires the use of a PLL and a VCO, both analog components. Analog components, though they allow for continuous tuning, cannot be programmed to do numerous tasks, without providing several implementations and a switch between them. Additionally analog components are more costly to operate, and tend to require more power than their digital counterparts.

It is, therefore, desirable to provide a method and system for recovering and generating a clock signal from recovered timestamps in a data stream that does not rely on analog components.

### SUMMARY OF THE INVENTION

It is an object of the present invention to obviate or mitigate at least one disadvantage of previous systems and methods for recovering and generating a clock signal from recovered timestamps in a data stream.

In a first aspect, the present invention provides a method of synchronizing an internal clock in a communications system having the steps of extracting a timestamp from a received signal, determining a difference between the timestamp and a time value of the internal clock and modifying a rate of change of the internal clock when the magnitude of the difference exceeds a rate of change threshold. In an embodiment of the first aspect of the present invention there is provided the method as described above, preceded by the step of extracting a timestamp from the received signal and setting the internal clock to a value derived from the value of the timestamp.

In a further embodiment, there is provided a method of synchronizing the internal clock of a receiver to the time values transmitted in timestamps in a data stream having the steps of extracting a timestamp from a received signal and setting the internal clock of the receiver to a value derived from the value of the timestamp. The next step is to extract a subsequent timestamp from the received signal, and determine the difference between the subsequent timestamp and the new time value of the clock. A fault threshold is then incremented if the absolute value of the determined difference is greater than a fault counter. The frequency, or rate of change, of the clock is modified if the absolute value of the determined difference is greater than a rate of change threshold, whether the clock is sped up or slowed down is determined by whether the internal clock leads or lags the timestamp value.

In a further aspect, the present invention provides a system for synchronizing the clock of a receiver to the value of a timestamp having a timestamp extractor, which extracts timestamps from a data stream and derives a time value from the extracted timestamp. The system also has a clock controller, which is connected to the timestamp extractor of examining selected timestamps and digitally modifying the internal clock time value, in response to the timestamp derived time value, In certain embodiments of the present invention the system described above may have a comparator for comparing the timestamp derived time value to the time value of the internal clock, and for providing both the magnitude of the difference, if any, and indication of whether the internal clock is lagging or leading the time value of the timestamp. Additionally the system may have an oscillator for controlling the rate of change of the internal clock, and means for adjusting the rate of change provided by the oscillator. Other additional components include a pattern table for superimposing a pattern on the oscillator output for synthesizing various clock rates.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is an overview of a system of the present invention;

FIG. 2 is a flow chart detailing a method of the present invention;

FIG. 3 is a flow chart detailing a method of the present invention;

FIG. 4 is an illustration of different clock pulses;

FIG. 5 is an illustration of a seeded clocking sequence;

FIG. 6 is a schematic overview of a system of the present invention;

FIG. 7 is a schematic overview of a system of the present invention;

FIG. 8 is a schematic overview of a system of the present invention;

FIG. 9 is a schematic overview of a system of the present invention;

FIG. 10 is a block diagram of an embodiment of a system of the present invention;

FIG. 11 is a block diagram of a DDS Finite State Machine;

FIG. 12 is an illustration of a seeded clocking sequence;

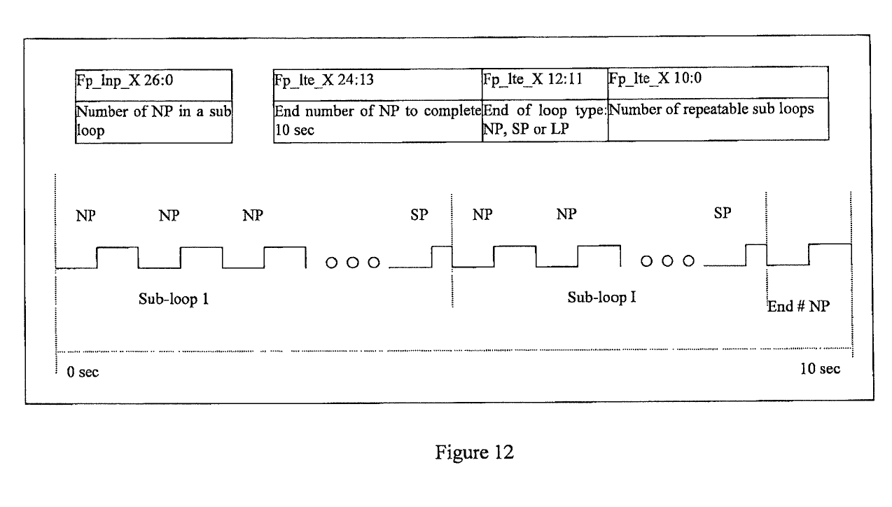

FIG. 13 is a block diagram of a timestamp extractor of the present invention; and

FIG. 14 is a block diagram of a clock controller of the present invention.

### DETAILED DESCRIPTION

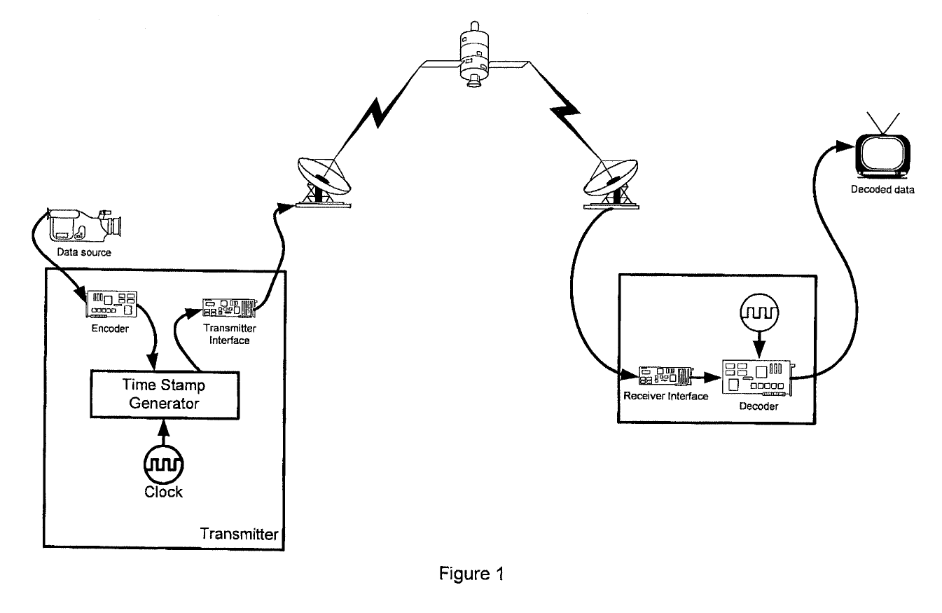

Generally, the present invention provides a method and system for recovering and generating a clock signal from recovered timestamps in a data stream. FIG. 1 illustrates an exemplary embodiment of the system of the present invention. The system 50 comprises a data source 52, which can be a video or other real time data source, or a static data source, connected to a transmitter 54. The transmitter 54 forms a synchronous link with the receiver 66. Regardless of the type of data provided by the data source 52 a synchronous link is provided. The transmitter 54 comprises an encoder 56, which receives the data from the data source 52, and prepares it for transmission. The data is then given a timestamp to denote either the encoding time or the transmission time. The timestamp is applied to the encoded data by the time stamp generator 58. The time stamp generator 58, is operatively connected to a clock 60, which supplies the time with which to encode the data. The time stamped data is then provided to a transmitter interface 62. The elements of the transmitter 54 are known to the art and can take any known configuration without changing the scope of the present invention. The transmitter 54 provides the timestamp encoded data to a transmission channel 64, which is depicted here as a satellite link, but could be any transmission medium. The transmission medium 64 transfers the data to the receiver 66. The receiver 66 is comprised of a receiver interface 68, which accepts the data stream from the transmission medium 64, and a decoder 138, which is operatively connected to a clock 144. The decoder 138 is described in further detail in descriptions of other figures, but includes a clock controller 146 and a timestamp extractor 140. The decoder 138 decodes the received data stream and provides a decoded data stream 70.

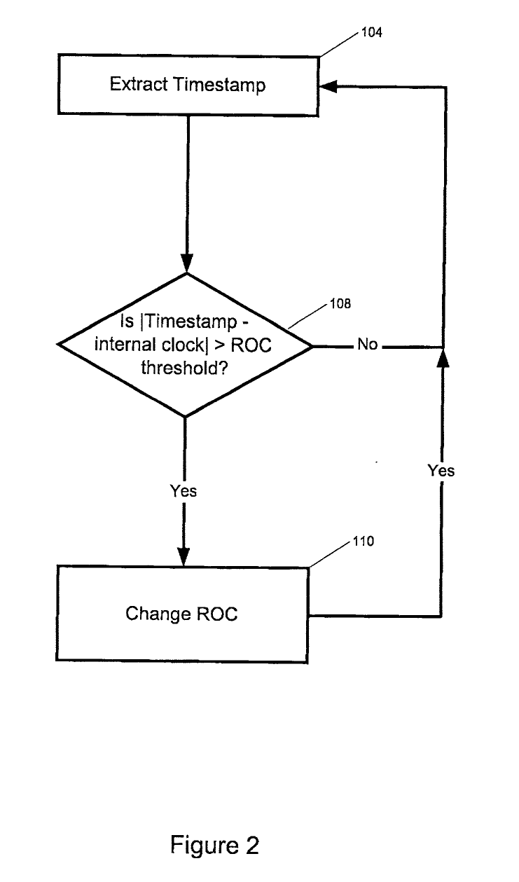

FIG. 2 illustrates a method of the present invention, and is described with reference to the elements of the exemplary system of FIG. 1. With an internal clock 144 set to approximately the correct time, timestamps are extracted in step 104, by the time stamp extractor (TSE) 140 and the internal clock 144 is compared to a rate of change (ROC) threshold in step 108. If the threshold is exceeded in step 108 then the ROC is modified in step 110, and the process restarts with step 104. This method will result in convergence of the internal clock 144 of the receiver 66 to the timestamp over a long window of time. Oscillations during the convergence are sized in relation to the initial difference between the timestamp and the internal clock value, the closer the two are the less the internal clock 144 will be varied.

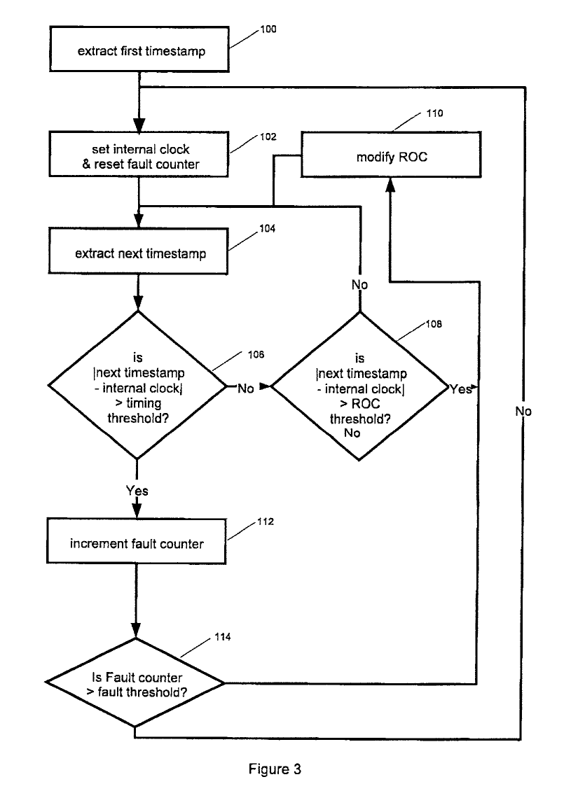

FIG. 3 illustrates a more detailed method of the present invention, and is described herein with reference to the elements of the exemplary system of FIG. 1. In a first step 100, a first timestamp is extracted from an asynchronous data stream, by a TSE 140. It should be noted that this method is equally applicable, to synchronous and asynchronous transfer systems, though there is less need for this method in a synchronous environment. The extracted timestamp is used in step 102 to set the receiver's clock 144, which has a frequency that is nominally the same as the transmitter 54. Due to a variety of factors such as differences in power supply consistency, slightly difference characteristics in clock crystals or oscillators, and different temperatures, applicable to both receiver 66 and transmitter 54, it can be assumed that the transmitter and receiver clocks, 60 and 144 respectively, will not be at the same frequency, at least at start-up of the receiver 66. A subsequent timestamp is extracted in step 104, from a second data unit. The subsequent timestamp and the internal clock 144 are compared to each other in step 106 to determine if their difference exceeds a timing threshold. This threshold is used to determine the difference between the transmitter and receiver clocks, 60 and 144 respectively, If the clocks have drifted a large amount, it may be the result of a one-time error, such as noise degrading the timestamp, a result of the two clocks having drifted too far apart, or the result of an improper synchronization at the start of the process. If the threshold has been exceeded in step 106, then a fault counter is incremented in step 112. The fault counter is maintained to allow for the one-time errors mentioned earlier. In step 114, the fault counter is compared to a fault threshold. If the fault threshold is exceeded it is assumed that the receiver clock has drifted too far, too many times, and is out of sync. In the event that the fault threshold is exceeded in step 114 then the internal clock is reset with a value derived from the current timestamp in step 102 and the fault counter is reset. If the fault threshold is not exceeded in step 114 then the difference between the new timestamp and the internal clock 144 is used to set an adjustment to the internal clock frequency in step 110. If, in step 106, the timing threshold is not exceeded, the difference between the timestamp and the internal clock 144 is compared to a rate to change threshold in step 108. This determination is performed to determine if the clocks are in adequate synchronization, or if they are close, but still need to be brought closer together. If the difference is less than the rate of change threshold, then no change is made to the clocks and the next timestamp is extracted in step 104. If the rate of change threshold is exceeded then the rate of change, or frequency of the clock is altered, and the system proceeds to step 104 and extracts a new timestamp for the process to continue. Though in this example every frame has a timestamp, it in not necessary for each frame to have a timestamp, nor is it necessary for the system to examine each timestamp. The percentage of timestamps examined can vary dependant upon the accuracy demanded by the implementation.

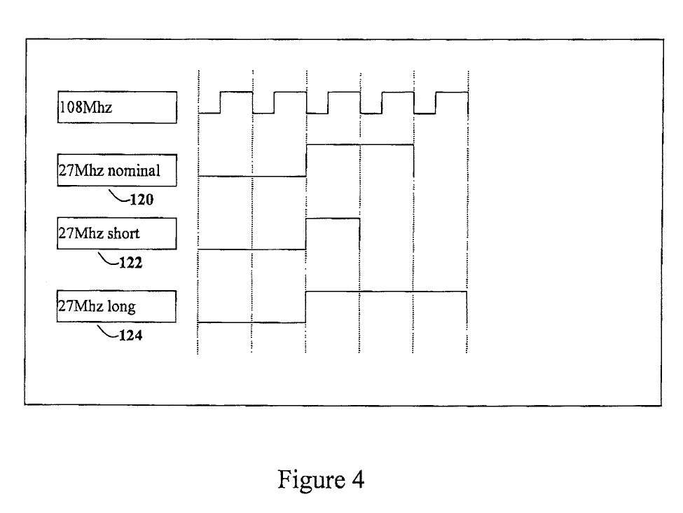

In step 110 the rate of change of the internal clock 144 is varied. To explain the novel method of altering the clock rate it is important to understand how the clock is maintained. Typically the transmitter clock is set to a nominal value, such as 27 MHz. The receiver will need to match the variations in the transmitter clock 60, so designing a clock to a nominal value of 27 MHz would not be appropriate. Instead, a clock is designed to operate at an integer multiple of the transmitter, such as 108 MHz (27×4). A clock at 27 MHz, will alternate between 0 and 1, 27 million times in one second. As shown in FIG. 4, duplication of a 27 MHz clock with a 108 MHz clock is performed by producing a pattern of “0011”, also referred to as 27 MHz nominal 120, and repeating that pattern 27 million times in one second. This technique allows for a novel method of modifying the clock in response to the request of the clock controller. A pattern of “0011” repeated five times takes twenty clock cycles. If it is necessary to slow the clock slightly, four repetitions of “00011”, which also takes twenty clock cycles, can be performed. The slightly longer cycle has the effect of slowing the clock without the use of analogue components. If the desire is to speed up a clock that is slightly lagging the transmitter, then replacing three cycles of “0011”, with four cycles of “001” will achieve the result.

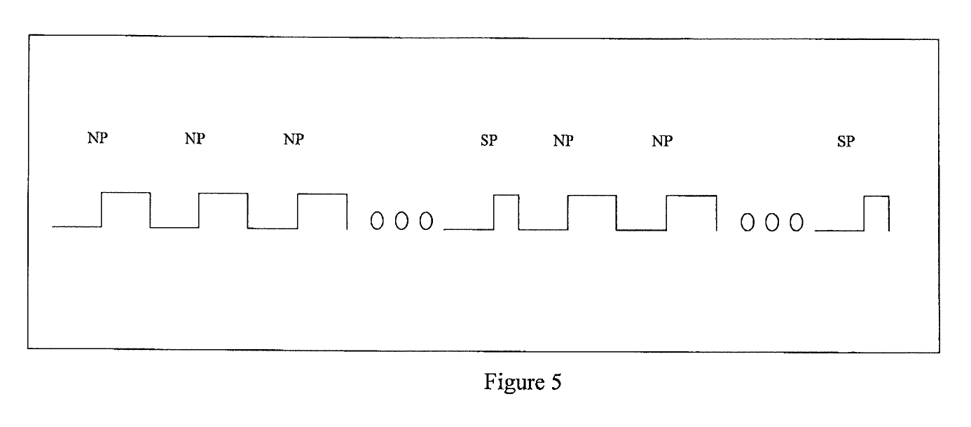

This technique, as illustrated in FIG. 5, is referred to as seeding, as not every cycle is replaced with a longer or shorter one, instead the altered clock cycles are seeded into the nominal stream of “0011”. The pattern for various speedups and slowdowns can be stored in a table accessible by a clock control device. The clock control device will load a pattern for the clock from the table, and uses that pattern until it is instructed otherwise. When the rate of change is modified at step 110, the comparison of the timestamp and the internal clock is used to determine whether the internal clock is lagging or leading the timestamp. If the clock is lagging, and requires a speedup, then the clock pattern one increment faster than the presently used pattern is loaded and used. Conversely if the clock is leading, and requires to be slowed down, then the clock pattern one increment slower than the presently used pattern is loaded and used. In other embodiments the degree of lagging or leading is examined and used to determine how much the clock pattern should be altered. The process of incrementally stepping through the table assumes that the clock is close to the timestamp. If the clock is very different than the timestamp, then systemic problems, such as a failure to properly acquire a timestamp, have likely occurred. Because this method does not allow more than an incremental change in the clock rate it does not allow very rapid response to clock problems, but after coming close to the timestamp, the clock steadies towards the signal with very little variance. A method of altering the clocking pattern dramatically will allow for rapid realignment of the clock to the timestamp, but is very susceptible to noise induced problems, though it is clearly foreseeable to someone of skill in the art that such a method could be easily implemented within the scope of the present invention.

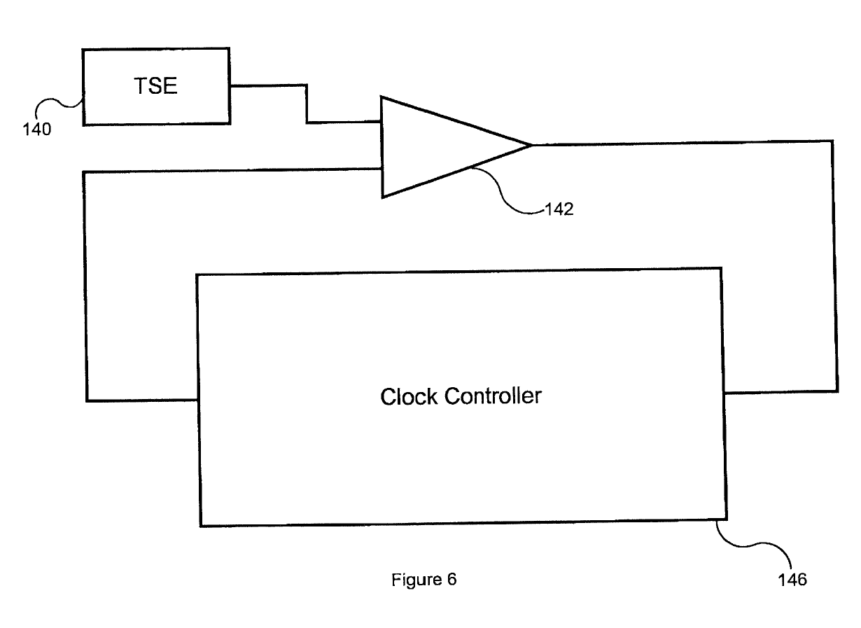

FIG. 6 illustrates an embodiment of the system of the present invention. Timestamp Extractor (TSE) 140 receives a data unit as input, and provides as its output a timestamp associated with the received data unit. Typically the timestamp is embedded in the data unit, but it could be transmitted in a control channel, or other means that would be apparent to one skilled in the art. The timestamp is provided as the first input to comparator 142. A clock controller 146 provides a timing signal, containing a time value as the second input to the comparator 142. Comparator 142 examines the timestamp and the time value and determines the difference between them. The determined difference is provided to the clock controller 146 as input. The clock controller 146 is a digital component, whereas in prior art systems the clock controller used analogue components. Internal to the clock controller 146 is the functionality to modify the frequency of the clock. Clocks are typically controlled by oscillators, which alternate between states at fixed intervals to maintain timings. As explained earlier the oscillator used in this system operates at an integer multiple of the transmitter clock. Thus the clock controller 146 adjusts the clock 144 by imposing a pattern on the oscillator's frequency to model the nominal clock rate, as discussed earlier. Thus the difference between the timestamp and the timing value, as determined by the comparator 142 is used by the clock controller 146 to change the rate of change of the clock in an attempt to match the future timestamps. It is also envisaged, though not illustrated, that the comparator 142 could be integrated with the clock controller 146, such that the TSE 140 communicates directly with the clock controller 146. All operations would then be internal to the controller 146.

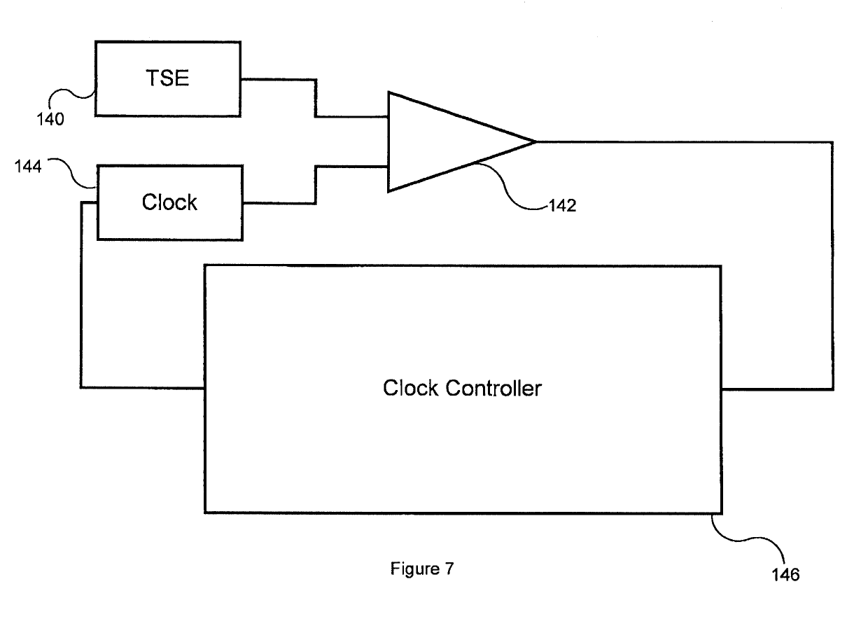

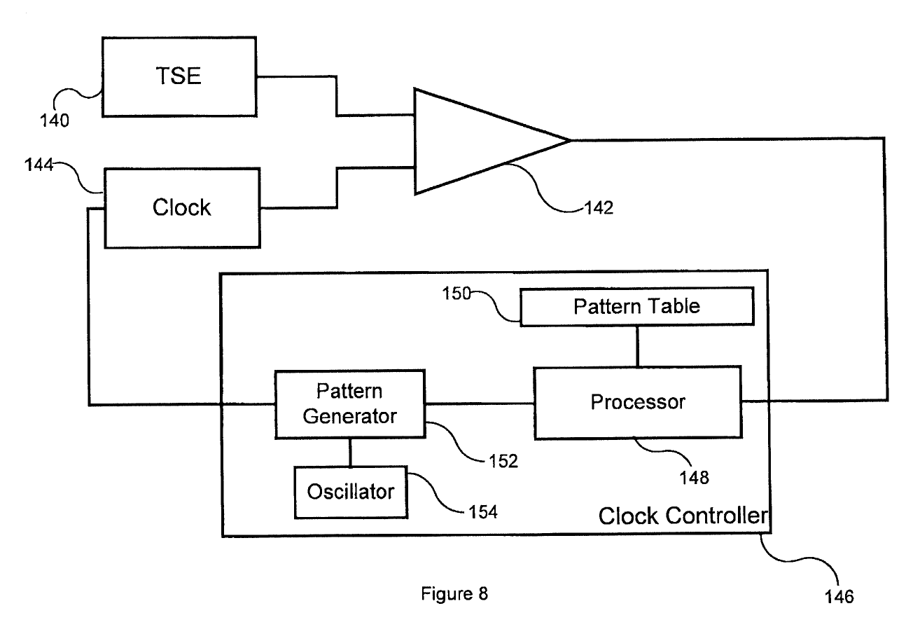

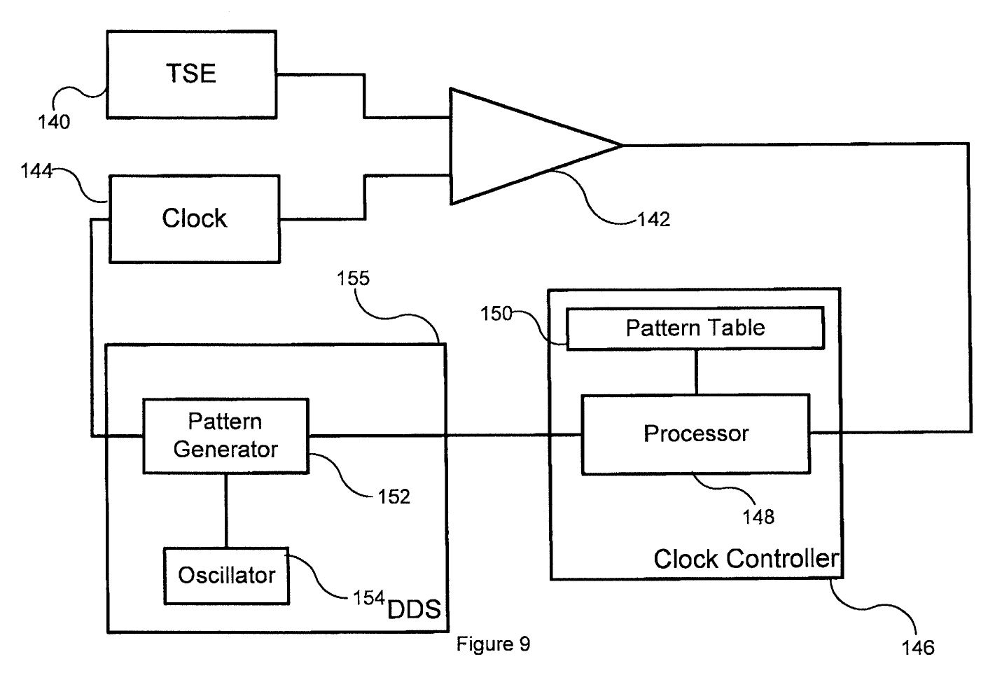

Another embodiment of the system of the present invention, with a clock distinct from the clock controller, is illustrated in FIG. 7. A Timestamp Extractor 140 receives a data unit and extracts from it a timestamp. The extracted timestamp value is provided to the comparator 142. The comparator 142 is operatively connected the clock 144, which provides a second input. The clock 144 provides, as a second input the comparator 142, a time value. This time value is digitally stored and incremented periodically. In a simple implementation, the comparator 142 compares two registers that are used as counters. The first register is in TSE 140, and stores the timestamp value. The second register is the clock 144, which is incremented by the output of the clock controller 146. The comparator 142 determines the difference between the timestamp from the TSE 140 and the time value from the clock 144. The determined difference, and an indicator of whether the clock 144 is leading or lagging the timestamp, is provided to the clock controller 146. The clock controller 146 analyzes the result provided by the comparator 142 and adjusts the clock 144 accordingly. A simple representation, wherein the clock controller 146 only varies the frequency of the clock 144 is presented in FIG. 8. The clock controller 146 is comprised of a processor 148, which analyzes the comparator's results, a pattern table 150 which lists the various timing patterns and is connected to and accessed by the processor 148, a pattern generator 152 which is provided a pattern from the pattern table 150 by the processor 148, and an oscillator 154. The oscillator 154 interfaces with the pattern generator 152 to provide the output of the clock controller 146 which changes the value of the clock 144. In another embodiment, as illustrated in FIG. 9, the clock controller 146 is comprised of the processor 148 and the pattern table 150, while the pattern generator 152 and oscillator 154 are separated into the direct digital synthesis (DDS) block 155, which synthesizes the 27 MHz signal that is used to increment the value of the clock 144.

In one embodiment of the system, the TSE 140 receives a data unit from the data stream and extracts the timestamp associated with that data unit. The clock controller 146 examines selected timestamps provided by TSE 140. The first timestamp received is used to set the clock 144, which is implemented by means of a counter. The value of the clock 144 is incremented by the oscillating signal from the pattern generator 152. Upon receiving the subsequently selected timestamp from TSE 140, the processor 148 alters the pattern provided to the pattern generator 152 based upon the output of the comparator 142. This alteration in the pattern provided to the pattern generator 152, need not be incremental. After a predetermined number of timestamps that do not indicate drift of the internal clock 144, the processor 148 exits its acquisition mode. After exiting acquisition mode, the processor populates the pattern table 150 with generated seeded sequences so that the pattern used to synchronize the clock 144 to the transmitter is at the midpoint of the pattern table 150. The processor 148 then enters a tracking mode, wherein it seeks to track the minor changes in the transmitter oscillator. To track the transmitter oscillator, the TSE 140 proceeds as before, by extracting a timestamp from a data unit. The comparator 142 compares selected timestamp values to the value of the clock 144. The comparator 142 provides the result of the comparison to the clock controller 142. In the clock controller 142, the processor examines how far from the timestamp the clock 144 is. If the timestamp leads or lags the clock 144 by an amount between the ROC threshold and the fault threshold, the next faster or slower pattern in the pattern table 150 is selected as necessary. The selected pattern is provided to the pattern generator 152, and the clock 144 is set to a value derived from the timestamp. If the difference between the timestamp value and the clock 144 is greater in magnitude than the fault threshold, the processor 148 assumes this is as a result of a corrupted timestamp and it ignores the timestamp. The processor may generate an interrupt to alert a monitoring facility, such as a separate application run by a processor, that an aberrant timestamp was detected. This monitoring facility may restart the processor in acquisition mode if a sufficient number of aberrant timestamps are detected, as this may be interpreted as a loss of lock on the signal.

The TSE 140 is designed to be fully programmable and flexible. Thus it is adaptable to numerous standards that place time stamps in various positions inside the data units. Conventionally a TSE would look for a timestamp in a fixed place in a unit, but standards such as Data-Over-Cable Service Interface Specification (DOCSIS) allow for freeform placement of the timestamp. The programmability also allows the development of TSE 140 as a multi-protocol tool that can analyze data units from various protocols. The implementation of a specific, non-limiting, embodiment will now be discussed in detail for exemplary reasons. The following examples are not intended to limit the scope of the present invention, and are instead only to aid in understanding the implementation of a particular embodiment of the present invention.

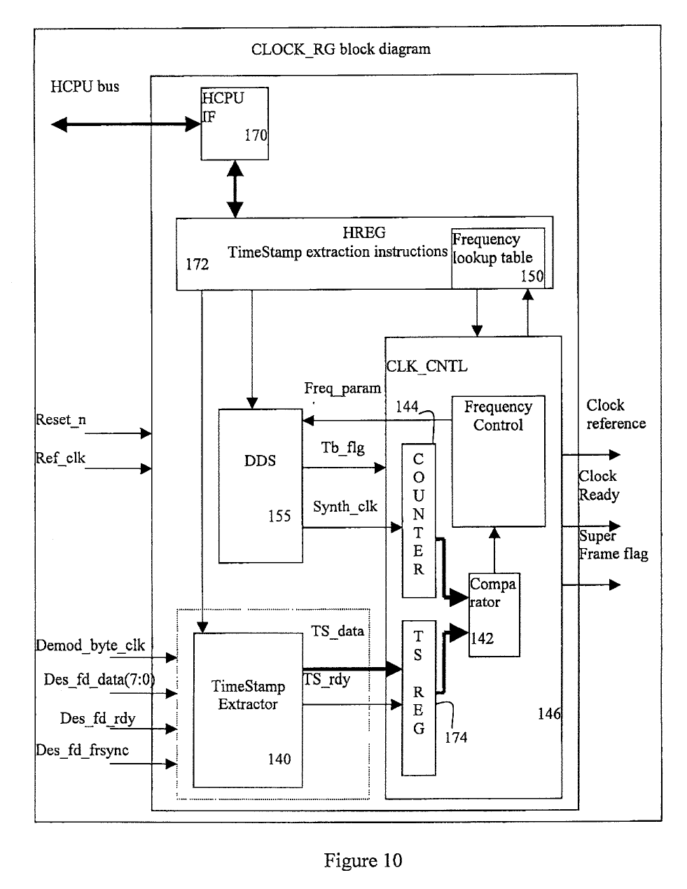

The system of the present invention, described herein as the clock_rg circuit, is shown in FIG. 10, and is constructed from two major blocks: the timestamp extractor 140 and the clock controller 146. The block has two modes of operation: basestation and terminal. In the basestation mode, the circuit generates a local reference clock and a timestamp for the terminals. In the terminal mode, the circuit recovers the timestamp from the data stream, which it uses to synchronize a local DDS clock.

The timestamp extractor circuit 140 parses the incoming data stream and extracts the associated timestamp. The circuit is based on a programmable byte processor. The user programs the circuit with byte manipulation instructions that extract the timestamp depending on the data stream protocol (SES-Astra or DOCSIS for example).

The circuit is activated by the frame sync flag, which indicates the start of an extraction program. The circuit then runs until the end of its instruction sequence, where it halts until the next frame sync flag. The timestamp extracted can be up to 6 bytes long.

To accommodate DOCSIS, a CRC-CCITT 16 and a CRC-CCITT 32 circuit are incorporated into the Timestamp Extractor block 140 which treats parallel data.

The timestamp extractor 140 is sequenced by the byte arrival times. Since there is no guaranteed minimum gap between successive bytes, it is therefore required to perform all parsing operations to be executed in 1 clock cycle. To achieve this, the timestamp extractor performs all branch, store and CRC operations in parallel. The defined instruction word is 64 bits wide and is stored in a register space to provide 32 instructions. The SES-Astra program requires 11 instructions and DOCSIS, 20 instructions.

Once a timestamp is recovered from the incoming data stream a flag is set and the timestamp is presented to the Clock Control block 146.

The clock controller 146 operates in two modes: basestation or terminal. In the basestation mode it is programmed to generate a reference clock and from the same clock, a timestamp. In the terminal mode, the circuit is programmed to synchronize a local direct digital synthesis (DDS) clock 155 to the basestation reference clock. The synchronization method is based on comparing the local timestamp with the one sent by the basestation. The clock control block 146 also generates the superframe pulse.

The HCPU 170 is the control interface block, which is slaved to the ASIC's 860/8260 CPU interface block.

The HREG block 172 contains the registers shared between the HCPU for programming and the engine blocks for operation control. It is detached from the HCPU because it is part of the respective engine's clock domain.

The TimeStamp Extractor block 140 is activated for the terminal mode. Its main function is to recover the protocol dependent timestamp from the downstream data. The block is configured for a particular protocol operation via the HCPU 170 register settings. After initialization, the block executes the programmed extraction algorithm block every time the frame sync is activated. If a timestamp is found, its value is loaded into the TS register 174 and the block then idles until the next frame sync.

The DDS Clock 155 is a direct digital synthesis clock circuit. This engine runs off a high-speed clock reference in order to synthesize a lower but variable frequency.

The Clock Control 140 is the main control engine. This block performs the following functions: implements a protocol dependent timing recovery algorithm in the terminal station mode; provides an accurate time base for base station mode; locks on and track to an upstream clock reference; controls the frequency selection of the DDS 155; controls the resetting of the DDS TS 144 counter; filters out erroneous timestamps; monitors the timestamp arrival times; synchronizes the timestamp values, which are generated from 2 asynchronous clocks.

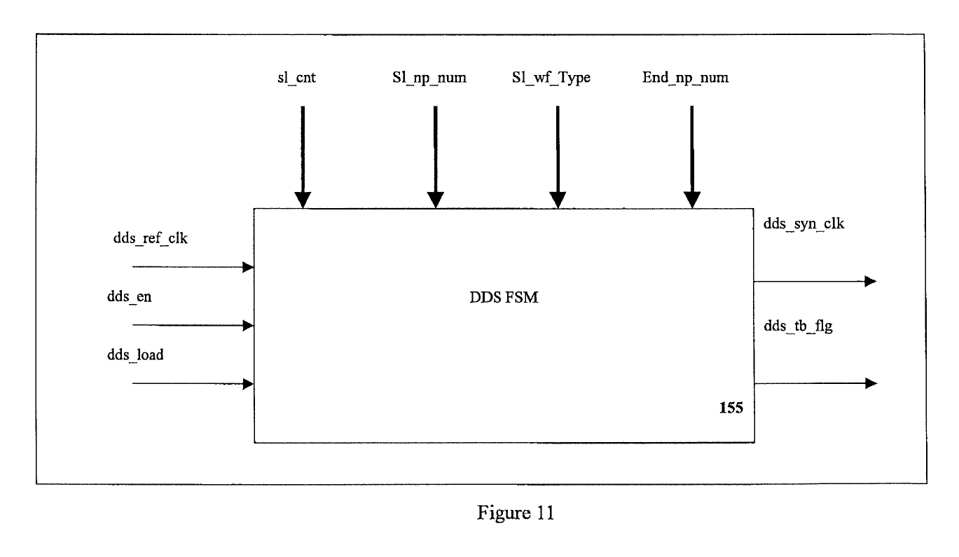

FIG. 11 is a block diagram of the DDS block 155 with signal inputs and outputs, as detailed in the following list.

Ref_clk: INPUT Clock that operates the FSM and is used as the reference for the synthesized output clock.

dds_en: INPUT. DDS FSM enable; reset and operation control.

dds_load: INPUT DDS frequency parameter load control. When asserted, DDS will wait until current clock cycle is complete then will restart FSM with new frequency parameters.

dds_clk: OUTPUT. Synthesized clock output

dds_tb_flg: OUTPUT. DDS timebase flag. Asserted when all parameters have been counted down to zero.

dds_en: INPUT. FSM enable; reset and operation control.

S1_cnt: INPUT. Sub loop count frequency parameter.

S1_np_cnt: INPUT. Sub loop nominal period count frequency parameter.

S1_wf_type: INPUT. Sub loop waveform type frequency parameter.

end_np_cnt: INPUT. Timebase end nominal period count frequency parameter.

To construct a nominal 27 mhz with a 50% duty cycle clock from a higher system clock requires a binary multiple: 54, 108, 216, etc. For physical ASIC considerations and for resolution requirements, the 108 mhz frequency is chosen (assuming that the duty cycle variation is acceptable). The types of possible waveforms are shown in FIG. 2 as described earlier.

By combining a sequence of nominal with either a short or long waveform, the DDS 155 can generate any frequency that varies in steps. For example, a sequence of 269999982 NP (nominal period) interspersed with 24 SP (short period) gives an average frequency of 2700000.6 Hz over a duration of 10 sec. The resulting waveform sequence is shown in FIG. 3, as previously described.

The DDS block 155 is implemented with a look up table 150 for the programmable frequency values and a state machine to run the sequence based on a frequency error input value. The lookup table entry for one frequency setting is as shown in FIG. 11.

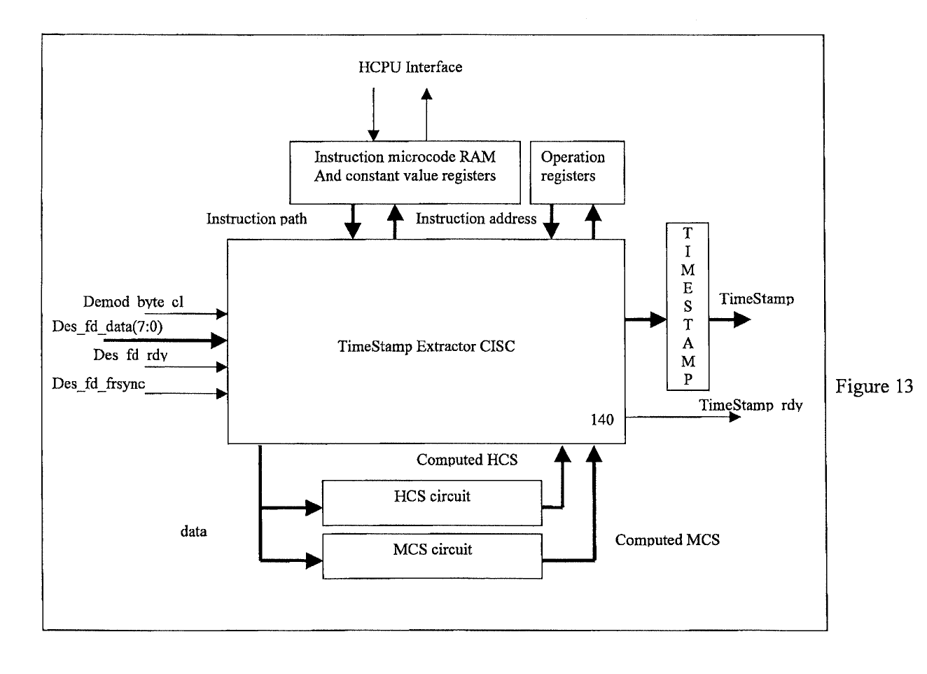

The TimeStamp Extractor block 140, shown in FIG. 13, is based on a CISC type processor that executes user programmed instructions to parse through an incoming data stream and extract a timestamp value. The timestamp extractor's features: extracting timestamp values from incoming data stream; qualifying timestamp for clock control block; count timestamp extraction errors for software (SW) diagnostics. The TSE 140 operates on 2 main input streams: frame sync and data bytes that arrive at the TSE's clock rate; and RAM instructions. The TSE is able to process the data on every clock. This constrains the instruction word format to be wide enough to describe all of the different types of operations that occur in parallel.

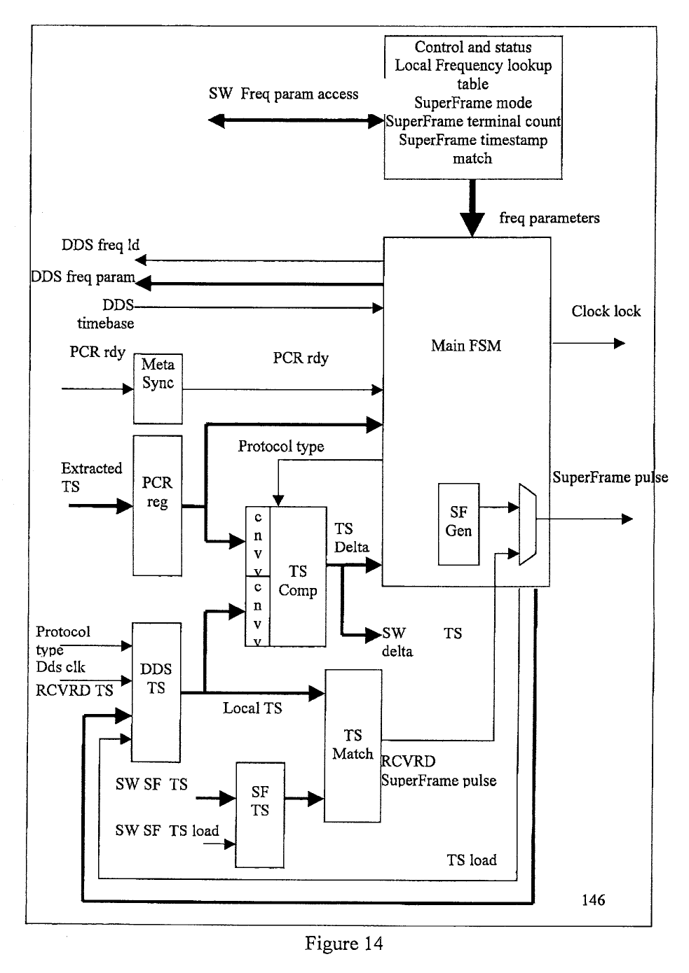

FIG. 14 shows the clock controller 146. The clock controller's features include: detecting loss of timestamp for SW diagnostics; setting DDS's 155 frequency under direct SW control; automatically varying DDS's 155 clock frequency according to the delta between local and extracted timestamps.

In the SES-Astra clock recovery mode a method of the present invention includes the steps of:

SW enables and programs CLOCK_RG for nominal frequency of 27 Mhz. Clock ready flag is off; hence TX mod is off.

SW enables receiver demodulator (RX demod) to receive incoming data stream.

SW programs first packet identified (PID) value for timestamp extraction. If the programmable clock reference (PCR) PID is unknown, SW can cycle through PID values until the prc_rdy flag is set, indicating that a possible timestamp has been found. PCR value is accessible by SW. Its occurrence is triggered by a TS_RDY interrupt.

CLOCK_RG waits for 1^{st} timestamp to preset internal counter and enable counting.

CLOCK_RG uses the 27 Mhz to increment the 42 bit counter where first 33 bits are in units of 90 Khz (base) and last 9 bits are remainder of 27 Mhz divided by 300 (ext).

Upon arrival of 2nd timestamp, this value is compared to timestamp generated via internal clock programmed for 27 Mhz to produce a delta containing the difference between the two. Delta instructs SW application, as to which range of frequency parameters to load into frequency selection table. Range is determined by on board reference clock uncertainty and specified system clock constraints: LTE 75*10**−3. This gives 0.75 Hz in 10 sec. Therefore a table of 32 values where each one has an accuracy of 0.1 Hz provides 200 sec of automatic clock tracking before SW needs to update the frequency parameter table. The SW then sets CLOCK_RG for tracking mode.

When DDS 155 reaches end of frequency timebase (10 sec) it flags the CLOCK_RG.

The following ts_rdy signal resets the DDS 155 for phase and new frequency table based on last valid PCR timestamp delta. The internal counter is updated with the timestamp associated with this delta. If this PCR is invalid (out of range due to bit error or discontinuity flag set), CLOCK_RG waits for next PCR. This loop repeats until either a valid PCR is received or number of invalid PCRs sets interrupt for loss of sync.

CLOCK_RG asserts the superframe flag every time it receives ts_rdy.

CLOCK_RG, when in tracking mode, compares the internal timestamp with the recovered value. It then performs the following based on the difference:

Base delta=0 (delta due to base station frequency variation specification)

Ext delta 0=Frequency lock.

Ext delta 1,2=Frequency lock. Index to next or second next frequency parameters in table and reset timestamp value. If index not in able, then interrupt SW for new frequency parameter table.

Ext delta>2=ignored on first and second occurrence, it is assumed that the PCR

is in error, set SW interrupt to record event. On third occurrence, CLOCK_RG operation is reset via SW.

Base delta>0=ignored on first and second occurrence, it is assumed that the PCR is in error, interrupt is set for SW to record event. On third occurrence, CLOCK_RG operation is reset via SW.

CLOCK_RG sets SW interrupt and resets clock_rdy when it detects more than 3 consecutive discontinuity indicator flags.

CLOCK_RG sets SW interrupt and resets clock_rdy when it detects a 600 msec period with no PCR TS.

In clock generation mode: SW enables and programs CLOCK_RG's DDS for nominal frequency of 27 Mhz. Clock ready flag is on.

CLOCK_RG uses the 27 Mhz to increment the 42 bit counter where first 33 bits are in units of 90 Khz and last 9 bits are remainder of 27 Mhz divided by 300.

SW programs and enables the superframe counter to generate the SuperFrame pulse.

In DOCSIS (clock recovery mode): SW enables and programs CLOCK_RG for nominal frequency of 10.24 Mhz. Clock ready flag is off; hence TX mod is off.

SW enables RX demod to receive incoming data stream.

SW programs PID (1FFE) value for timestamp extraction. CMTS timestamp value is accessible by SW. Its occurrence is triggered by a TS_RDY interrupt.

CLOCK_RG waits for 1^{st} timestamp to preset internal counter and enable counting.

Upon arrival of 2^{nd} timestamp (200 ms later), this value is compared to timestamp generated via internal clock programmed for 10.24 Mhz. Delta instructs SW application, which range of frequency parameters to load into frequency selection table. Range is determined by on board reference clock uncertainty and specified system clock constraints: constraints 10 ns jitter and 10**−8 drift rate=duration of adjacent 102,400,000 segments within LTE 120 ns. This gives 1.2 Hz in 10 sec. Therefore a table of 24 values where each one has an accuracy of 0.1 Hz is required. The SW then sets CLOCK_RG for tracking mode.

When DDS reaches end of frequency timebase (10 sec) it flags the CLOCK_RG. The following ts_rdy signal resets the DDS for phase and new frequency table based on last valid CMTS timestamp delta. The internal counter is updated with this timestamp. If this CMTS is invalid (out of range due to bit error or transport_error_indicator set), CLOCK_RG waits for next CMTS. This loop repeats until either a valid CMTS is received or number of invalid CMTS sets an interrupt for loss of sync.

CLOCK_RG asserts the superframe flag every time it receives ts_rdy.

CLOCK_RG in tracking mode compares the internal timestamp with the recovered value. It then performs the following based on the difference:

Delta 0=Frequency lock.

Delta 1,2=Frequency lock. Index to next or second next frequency parameters in table and reset timestamp value. If index not in table, then interrupt SW for new frequency parameter table.

Delta>2=ignored on first and second occurrence, it is assumed that the PCR is in error, set SW interrupt to record event. On third occurrence, CLOCK_RG operation is reset via SW.

CLOCK_RG sets SW interrupt and resets clock_rdy when it detects more than 3 consecutive transport_error_indicator flags.

CLOCK_RG sets SW interrupt and resets clock_rdy when it detects a 600 msec period with no CMTS TS.

In clock generation mode: SW enables and programs CLOCK_RG's DDS for nominal frequency of 10.24 Mhz. Clock ready flag is on.

CLOCK_RG uses the 10.24 Mhz to increment the 32 bit timestamp counter.

Advantages of the present invention include the following features: user programmability for timestamp extraction algorithms, protocol based timestamp generation for base stations, protocol based timestamp extraction for terminal stations, clock recovery for terminal stations, SuperFrame generation and detection, and DDS clock with a resolution of 0.1 Hz.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of synchronizing an internal clock in a communications system comprising:
a) extracting a timestamp from a received signal;
b) determining a difference between the timestamp and a time value of the internal clock; and
c) modifying a rate of change of the internal clock when the magnitude of the difference exceeds a rate of change threshold.

2. The method as in claim 1, preceded by extracting a first timestamp from the received signal and setting the time value of the internal clock to a value derived from the first timestamp.

3. The method as in claim 1, further including setting the time value to a value determined from the timestamp when the difference exceeds a timing threshold.

4. The method as in claim 1, wherein modifying the rate of change is preceded by:
i) incrementing a fault counter if the difference exceeds a timing threshold;
ii) setting the time value to a value determined from the timestamp, setting the difference to zero, and setting the fault counter to zero when the fault counter exceeds a fault threshold.

5. The method as in claim 1, wherein modifying the rate of change further includes replacing a set of N clock cycles, each comprising M pulses, with A clock cycles, each comprising B pulses, such that N×M is equal to A×B.

6. The method as in claim 5, wherein A>N.

7. The method as in claim 5, wherein A<N.

8. The method as in claim 1, wherein modifying the rate of change includes decreasing the rate of change when the time value leads the timestamp.

9. A method as in claim 1, wherein modifying the rate of change includes increasing the rate of change when the time value lags the timestamp.

10. A method of synchronizing an internal clock in a communications system comprising:
a) extracting an original timestamp from a received signal;
b) setting a time value of the internal clock to a value derived from the original timestamp;
c) extracting a subsequent timestamp from the received signal;
d) determining the difference between the subsequent timestamp and the time value;
e) incrementing a fault counter if the magnitude of the difference exceeds a timing threshold;
f) resetting the clock to a value determined from the subsequent timestamp if the fault counter exceeds a fault threshold; and
g) modifying the rate of change of the internal clock if the difference exceeds a rate of change threshold and does not exceed a timing threshold.

11. A clock synchronization system comprising
a timestamp extractor, for extracting a timestamp from a data stream, and for deriving a time value from said timestamp; and
a clock controller, operatively attached to the timestamp extractor and an internal clock, said internal clock having a time value, for receiving select time values derived from a timestamp, and for digitally modifying the internal clock time value, in response to the timestamp derived time value.

12. The clock synchronization system, as in claim 11, wherein the clock controller includes a comparator, operatively connected to the timestamp extractor and the internal clock, for determining a difference between the timestamp derived time value and the internal clock time value.

13. The clock synchronization system, as in claim 11, wherein the clock controller includes an oscillator for controlling a rate of change of the internal clock.

14. The clock synchronization system, as in claim 13, wherein the clock controller includes means for increasing the rate of change when the internal clock lags the timestamp derived time value.

15. The clock synchronization system, as in claim 13, wherein the clock controller includes means for decreasing the rate of change when the internal clock leads the timestamp derived time value.

16. An internal clock synchronization system comprising:
a comparator, having first and second inputs for receiving first and second input signals, for determining a difference between the first and second input signals and providing at a comparator output a difference signal representative of the determined difference;
a clock controller, operatively connected to the comparator output, for receiving the difference signal and for digitally deriving a timing correction signal therefrom, and for providing the digitally derived timing correction signal at a clock controller output;
a timestamp extractor, operatively connected to the first input of the comparator, for extracting a timestamp associated with a data unit and for providing a signal indicative of a timestamp value to the first input of the comparator; and
a clock, operatively attached to the clock controller output for receing the timing correction signal and operatively attached to the second input of the comparator for providing a signal indicative of an internal time value.

17. A system as in claim 16, wherein the clock controller further includes
a pattern table, for storing clock cycle patterns representative of different clock speeds;
a processor, operatively attached to the pattern table, for receiving the difference signal from the comparator output, and for retrieving clock cycle patterns from the pattern table based on the received difference signal, and for providing at a processor output a signal representative of the clock cycle pattern;
an oscillator, for providing at an oscillator output an oscillating signal; and
a pattern generator, operatively connected to the oscillator output and the processor output, for generating a digitally derived timing correction signal for the clock controller output based upon the oscillating signal and the signal from the processor.
